(19) United States
(12) Patent Application Publication
(10) Pub. No.: US 2024/0235142 A1
(43) Pub. Date: Jul. 11, 2024

(54) ELECTRONIC DEVICE ASSEMBLY APPARATUS AND ELECTRONIC DEVICE ASSEMBLY METHOD

(71) Applicant: NACHI-FUJIKOSHI CORP., Tokyo (JP)

(72) Inventors: Daisaku UCHIJIMA, Toyama (JP); Kei MIKAMI, Toyama (JP); Kyotaro MIMURA, Toyoma (JP)

(73) Assignee: NACHI-FUJIKOSHI CORP., Tokyo (JP)

(21) Appl. No.: 18/592,557

(22) PCT Filed: Jun. 17, 2022
(86) PCT No.: PCT/JP2022/024312

§ 371 Date: Mar. 5, 2024

(30) Foreign Application Priority Data
Jul. 2, 2021 (JP) 2021-110784

(51) Int. Cl. H01R 43/26

(52) U.S. Cl. CPC H01R 43/26

(57) ABSTRACT

To provide an electronic device assembly apparatus and an electronic device assembly method enabling a reliable connection work for multiple types of cables having different widths. An electronic device assembly apparatus includes a robot control device controlling a gripping device that grips a flexible flat cable and a robot arm moving the gripping device. The robot control device: moves the gripping device to press a pressing surface against a cable surface to slide the pressing surface toward the cable leading end while gripping claws and a suction hole are not operating causes the gripping claws to hold the cable to correct cable displacement in the width direction, causes the suction hole to suck the cable surface, and moves the gripping device to insert the cable leading end into a circuit board connector.

### FIELD OF THE INVENTION

The present invention relates to an electronic device assembly apparatus and an electronic device assembly method for gripping a cable connected to a circuit board of an electronic device or the like.

### BACKGROUND OF THE INVENTION

An electronic device assembly apparatus is used at a production site such as a plant, and performs connection work for connecting a leading end of a flat soft (flexible) cable such as an FPC (Flexible Printed Circuit) or an FFC (Flexible Flat Cable) to a connector (substrate-side connector) on a circuit board. The electronic device assembly apparatus includes a visual device such as a camera, a robot arm, and a controller that controls the visual device and the robot arm.

A cable is a soft elongated object having flexibility, and therefore, deforms in an unpredictable manner when it is bent or pressed. Accordingly, there is variation particularly in the position and posture of the leading end of the cable. It is difficult to recognize the leading end of the cable having such variation with use of the visual device of the electronic device assembly apparatus and to grip the leading end with use of the robot arm and insert the leading end into the substrate-side connector. Therefore, the connection work is performed manually in some cases. However, there is a problem that the work efficiency does not improve when accurate aligning between the leading end of the cable and the substrate-side connector is performed manually.

Therefore, the electronic device assembly apparatus is required to accurately grip the leading end of the cable in the connection work for connecting the leading end of the cable to the substrate-side connector. For example, Patent Document 1 describes an electronic device assembly method in which a second end portion of a cable is attached to a connector on a circuit board in a state where a first end portion of the cable including the first end portion and the second end portion is connected to an electronic circuit.

### PRIOR ART DOCUMENT

### Patent Document

Patent Document 1: Japanese Patent No. 6500247

### SUMMARY OF THE INVENTION

### Problems to be Solved by the Invention

In an actual production process performed at the production site, multiple types of cables having different widths are sometimes connected (soldered) to a circuit board. Accordingly, the electronic device assembly apparatus is required to be capable of holding multiple types of cables having different widths to perform connection work by inserting leading ends of the cables into connectors on the circuit board.

In the technology described in Patent Document 1, a cable holding tool is slid to a leading end of the cable, which is a final gripping target, while the cable is restricted in its width direction by the cable holding tool. The cable holding tool includes a pair of chucks and restricts the position of the cable in the width direction by driving an actuator to close the pair of chucks and sandwich the cable in the width direction.

Even when an attempt is made to slide the pair of chucks relative to the cable while the cable is restricted in the width direction by the pair of chucks, the pair of chucks may fail to slide due to a frictional force acting between the cable and the chucks depending on the magnitude of a gripping force with which the cable is gripped by the pair of chucks. In such a case, positions of the pair of chucks and the cable relative to each other do not change, and the cable holding tool pulls the cable in the state where the pair of chucks have not reached the leading end of the cable. Accordingly, the position of the leading end of the cable is unstable, and it is difficult to perform the connection work.

On the other hand, in the case of a configuration in which a cable is sandwiched in the width direction by a guide or the like that does not open and close in the width direction and has a fixed width, it is possible to hold a cable that fits the fixed width, but it is not possible to hold multiple types of cables having different widths.

In view of the above problems, the present invention has an object of providing an electronic device assembly apparatus and an electronic device assembly method with which connection work for connecting multiple types of cables having different widths can be performed.

### Means to Solve the Problem

In order to solve the above problems, a representative configuration of an electronic device assembly apparatus according to the present invention includes: a gripping device that grips a flexible flat cable including a leading end that is a free end; a robot arm that moves the gripping device relative to a circuit board to which a base of the cable has been electrically connected; and a robot controller that controls operations of the gripping device and the robot arm, wherein the gripping device includes: a pressing surface that is provided on a front surface of the gripping device and pressed against a surface of the cable; gripping claws that are located outward of the pressing surface in a width direction and hold the cable by sandwiching the cable in the width direction; and a suction device that is provided in a lower surface of the gripping device and holds the cable by sucking the surface of the cable, and the robot controller moves the gripping device to press the pressing surface against the surface of the cable, slides the pressing surface toward the leading end of the cable while bending the cable with use of the pressing surface in a state where the gripping claws and the suction device are not operating, after sliding the pressing surface, causes the gripping claws to hold the cable to correct displacement of the cable in the width direction, after holding the cable, causes the suction device to suck the surface of the cable by sucking air, and moves the gripping device to insert the leading end of the cable into a connector on the circuit board.

According to this configuration, the pressing surface is slid toward the leading end of the cable by moving the gripping device while the cable is bent by pressing the pressing surface against the surface of the cable, without the gripping claws and the suction device being operated, and thereafter, the cable is held and then sucked. That is, when the pressing surface is slid along the surface of the cable while being pressed against the surface, the cable is not restricted in the width direction and the surface of the cable is not sucked. Therefore, the gripping device can hold multiple types of cables having different widths.

After the pressing surface has been moved to the leading end of the cable, the cable is held by the gripping claws to correct displacement of the cable in the width direction, and then the surface of the cable is sucked by the suction device. As a result, the position of the leading end of the cable is stabilized, and therefore, it is possible to reliably insert the leading end of the cable into the connector on the circuit board by moving the gripping device and complete the connection work. According to this configuration, it is possible to perform connection work for connecting multiple types of cables having different widths.

In order to solve the above problems, a representative configuration of an electronic device assembly apparatus according to the present invention includes: a gripping device that grips a flexible flat cable including a leading end that is a free end; a robot arm that moves the gripping device relative to a circuit board to which a base of the cable has been electrically connected; and a robot controller that controls operations of the gripping device and the robot arm, wherein the gripping device includes: a pressing surface that is provided on a front surface of the gripping device and pressed against a surface of the cable; gripping claws that are located outward of the pressing surface in a width direction and hold the cable by sandwiching the cable in the width direction; and a suction device that is provided in a lower surface of the gripping device and holds the cable by sucking the surface of the cable, and the robot controller moves the gripping device to press the pressing surface against the surface of the cable, slides the pressing surface along the surface of the cable while bending the cable with use of the pressing surface in a state where the gripping claws and the suction device are not operating, moves the gripping device downward, causes the gripping claws to hold the cable to correct displacement of the cable in the width direction, causes the suction device to suck the surface of the cable by sucking air, releases the cable from the gripping claws, moves the gripping device upward while the cable is sucked by the suction device, causes the gripping claws to hold the cable again, and moves the gripping device to insert the leading end of the cable into a connector on the circuit board.

According to this configuration, the pressing surface is slid along the surface of the cable by moving the gripping device while the cable is bent by pressing the pressing surface against the surface of the cable, without the gripping claws and the suction device being operated. That is, when the pressing surface is slid along the surface of the cable while being pressed against the surface, the cable is not restricted in the width direction and the surface of the cable is not sucked. Therefore, the gripping device can hold multiple types of cables having different widths.

Also, the gripping device is moved downward after the pressing surface has been moved to the leading end of the cable, and thus the cable can be bent more reliably. Furthermore, the surface of the cable is sucked by the suction device after displacement of the cable in the width direction is corrected by holding the cable with use of the gripping claws. Thus, the position of the leading end of the cable can be stabilized.

At this time, even if the leading end of the cable extends obliquely downward with respect to the lower surface of the gripping device, it is possible to make the leading end of the cable extend horizontally to reliably suck the cable by temporarily releasing the cable from the gripping claws and moving the gripping device upward while the surface of the cable is sucked.

Accordingly, by holding the horizontally-extending cable again and moving the gripping device, it is possible to reliably insert the horizontally-extending leading end of the cable into the connector on the circuit board to complete the connection work. According to the above configuration, it is possible to more reliably perform the connection work for connecting multiple types of cables having different widths.

In order to solve the above problems, a representative configuration of an electronic device assembly method according to the present invention is an electronic device assembly method for inserting a leading end of a flexible flat cable into a connector on a circuit board, the cable including a base that has been connected to the circuit board and the leading end that is a free end, the method including: moving a gripping device including: a pressing surface that is provided on a front surface of the gripping device and pressed against a surface of the cable; gripping claws that are located outward of the pressing surface in a width direction and hold the cable by sandwiching the cable in the width direction; and a suction device that is provided in a lower surface of the gripping device and holds the cable by sucking the surface of the cable; pressing the pressing surface against a side surface of the cable; sliding the pressing surface toward the leading end of the cable while bending the cable with use of the pressing surface in a state where the gripping claws and the suction device are not operating; after sliding the pressing surface, causing the gripping claws to hold the cable to correct displacement of the cable in the width direction; after holding the cable, causing the suction device to suck the surface of the cable by sucking air; and moving the gripping device to insert the leading end of the cable into the connector on the circuit board.

Constitutional elements corresponding to the technical idea of the electronic device assembly apparatus described above and descriptions of those elements are also applicable to the method, and with this configuration, it is possible to perform connection work for connecting multiple types of cables having different widths.

### Effects of the Invention

According to the present invention, it is possible to provide an electronic device assembly apparatus and an electronic device assembly method with which it is possible to perform connection work for connecting multiple types of cables having different widths.

### BRIEF EXPLANATION OF THE DRAWINGS

FIG. 1 is an overall configuration diagram of a robot system to which an electronic device assembly apparatus according to an embodiment of the present invention is applied.

FIG. 2 is a diagram showing a part of the electronic device assembly apparatus shown in FIG. 1.

FIG. 3 is a block diagram showing functions of the robot system shown in FIG. 1.

FIG. 4A is a diagram showing a gripping device as viewed from obliquely below.

FIG. 4B is a diagram showing the gripping device as viewed from obliquely above.

FIG. 5 is a block diagram showing functions of the electronic device assembly apparatus shown in FIG. 3.

FIG. 6A shows a state where a pressing surface of the gripping device is pressed against a surface of a cable.

FIG. 6B shows a state where the pressing surface is slid while being pressed against the surface of the cable.

FIG. 6C shows a state where the gripping device is moved downward.

FIG. 6D shows a state where a leading end of the cable extends obliquely downward.

FIG. 6E shows a state where the cable is temporarily released and the gripping device is moved upward in a state where the surface of the cable is sucked via suction holes.

FIG. 6F shows a state where the cable extending horizontally is held again by gripping claws.

### EMBODIMENTS OF THE INVENTION

A preferred embodiment of the present invention is described below in detail with reference to the attached drawings. Dimensions, materials, other specific numerical values, and the like described in the embodiment are merely examples for facilitating understanding of the present invention, and do not limit the present invention unless otherwise stated. In the specification and the drawings, elements that have substantially the same function and configuration are denoted by the same reference numeral, and a redundant description of such elements is omitted. Also, illustration of elements that do not directly relate to the present invention is omitted.

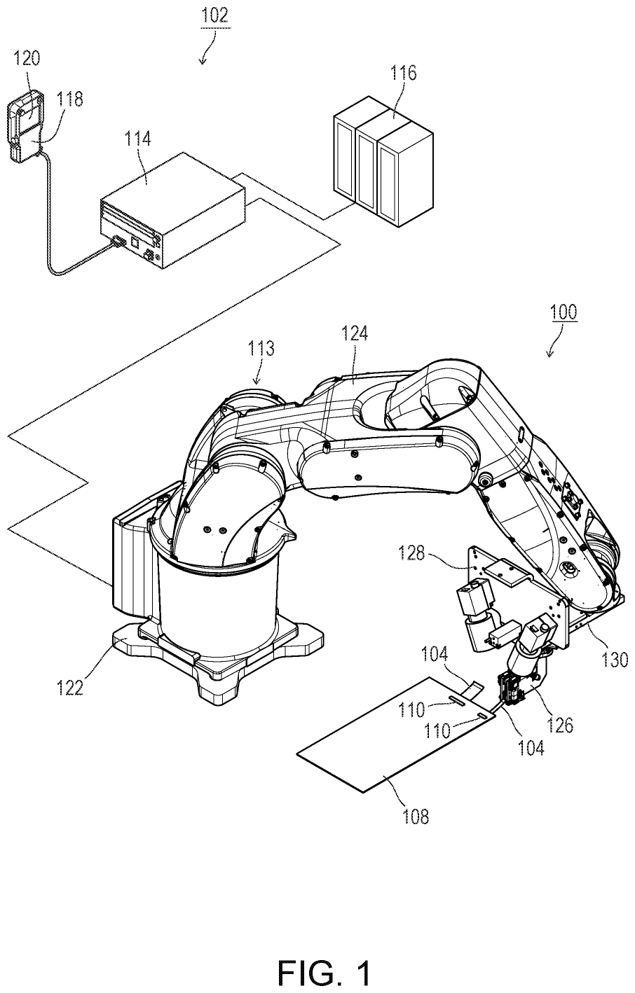

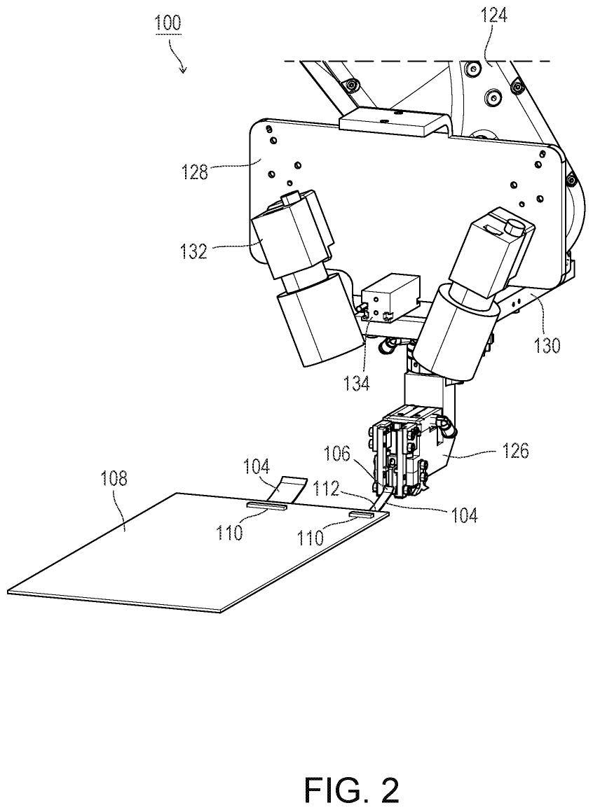

FIG. 1 is an overall configuration diagram of a robot system 102 to which an electronic device assembly apparatus 100 according to an embodiment of the present invention is applied. FIG. 2 is a diagram showing a part of the electronic device assembly apparatus 100 shown in FIG. 1. The electronic device assembly apparatus 100 is used at a production site such as a plant, and automatically performs connection work for electrically connecting (inserting) a leading end 106 of a cable 104 shown in FIG. 2 to a connector 110 on a circuit board 108, which is a connection target.

The cable 104 is a flat elongated cable having flexibility such as an FPC or an FFC. The cable 104 is highly flexible, and a portion of the cable 104 can be bent in an arc shape. The cable 104 includes a base 112 that is connected (soldered) to the circuit board 108, and the leading end 106 of the cable 104 is a free end.

In an actual production process performed at the production site, multiple types of cables 104 having different widths are sometimes connected to the circuit board 108. Therefore, in the electronic device assembly apparatus 100, a configuration is adopted that makes it possible to hold multiple types of cables 104 having different widths and perform connection work by inserting leading ends 106 of the cables 104 into connectors 110 on the circuit board 108.

The electronic device assembly apparatus 100 includes a robot body 113 shown in FIG. 1 and a robot controller 114 connected to the robot body 113. The robot system 102 includes an upper-level control system 116, an input device 118, and a state notification device 120 that are connected to the robot controller 114, in addition to the electronic device assembly apparatus 100. The input device 118 is a device for inputting commands, parameters, and the like to the robot controller 114. The state notification device 120 is a device that receives and displays an operation state of the robot body 113 and a state of the connection work, which are transmitted from the robot controller 114.

The robot body 113 includes a base 122 shown in FIG. 1, a robot arm 124 connected to the base 122, a gripping device 126, and a visual device 128. The gripping device 126 is attached to a leading end 130 of the robot arm 124 as shown in FIG. 2 and grips a cable 104.

As shown in FIG. 2, the visual device 128 is an imaging device that captures images of the cable 104 and the like. The visual device 128 is attached so as to face downward toward the leading end 130 of the robot arm 124. The visual device 128 includes a camera 132, which is a visual sensor, and a lighting device 134 that lights up the circuit board 108 and the cable 104.

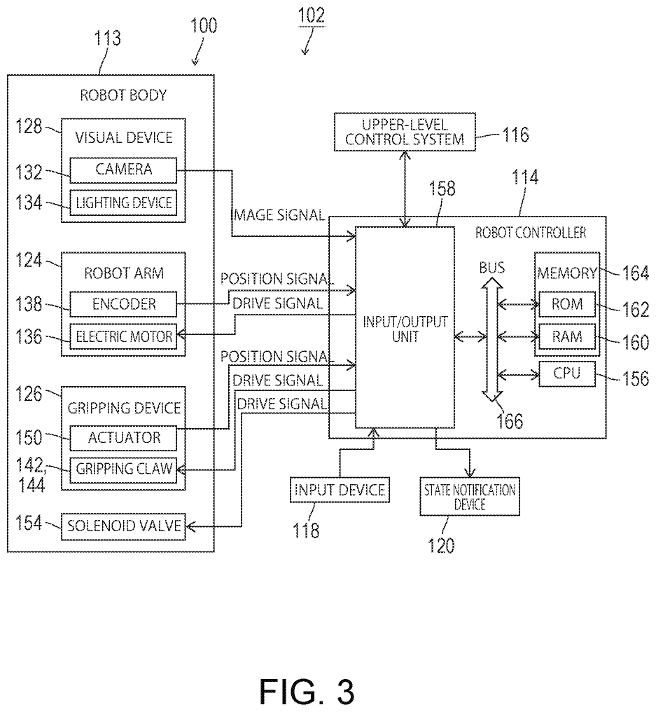

FIG. 3 is a block diagram showing functions of the robot system 102 shown in FIG. 1. The robot arm 124 is a six-axis vertical articulated robot, and includes electric motors 136, which are actuators provided at joints of the robot arm, and encoders 138 that detect positions of the joints. The encoders 138 output position signals indicating detection results of the positions of the joints to the robot controller 114. The robot controller 114 generates drive signals for driving the electric motors 136 based on the position signals received from the encoders 138. The electric motors 136 are driven by the drive signals output from the robot controller 114 and realize target operations of the robot arm 124 in the connection work.

With this configuration, the robot arm 124 can move the gripping device 126 attached to its leading end 130 as shown in FIG. 2 to a predetermined position. Note that the robot arm 124 is not limited to a six-axis vertical articulated robot, and may also be a vertical articulated robot in which the number of axes is not six, or a horizontal articulated robot, for example.

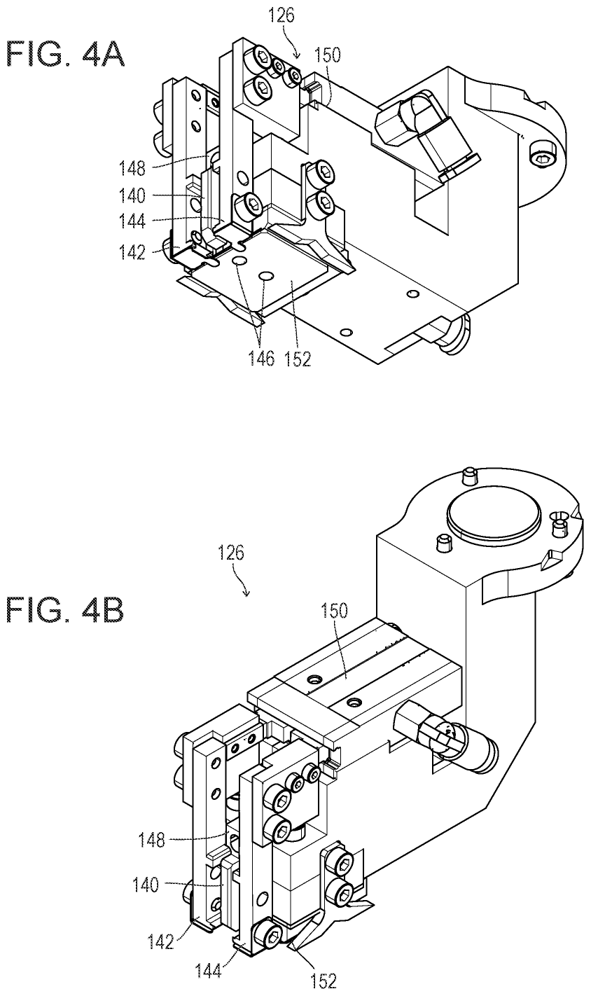

FIG. 4A is a diagram showing the gripping device 126 as viewed from obliquely below, and FIG. 4B is a diagram showing the gripping device 126 as viewed from obliquely above. The gripping device 126 includes a pressing surface 140, a pair of gripping claws 142 and 144, and suction holes 146 shown in FIG. 4A. The pressing surface 140 is provided on a front surface 148 of the gripping device 126 and pressed against the cable 104. The gripping claws 142 and 144 are located outward of the pressing surface 140 in the width direction and perform opening and closing operations so as to approach each other or separate from each other in response to being driven by an actuator 150, and thus hold the cable 104 by sandwiching the cable 104 in the width direction, or release the cable 104.

The suction holes 146 are provided in a lower surface 152 of the gripping device 126 shown in FIG. 4A and serve as a suction device that holds the cable 104 by sucking the cable 104. The suction holes 146 are in communication with a vacuum pressure creating source such as an ejector, and a vacuum is created by feeding compressed air to the ejector through an operation of a solenoid valve 154 shown in FIG. 3. The solenoid valve 154 that controls the suction holes 146 serving as the suction device is provided in the robot body 113 as shown in FIG. 3 and operates upon receiving a drive signal from the robot controller 114. However, there is no limitation to the configuration in which the solenoid valve 154 is provided in the robot body 113, and the solenoid valve 154 may be provided in an element included in the robot system 102. Although two suction holes 146 are provided in the illustrated example, there is no limitation to this configuration, and the number of suction holes 146 may be one, or three or more.

Here, the elements shown in FIG. 3 will be described in detail. The camera 132 and the lighting device 134 included in the visual device 128 are attached to the leading end 130 of the robot arm 124 (see FIG. 1), but there is no limitation to this configuration, and the camera and the lighting device may be provided at a position other than the robot arm 113 so long as an overhead image of a work area of the connection work can be obtained. At least one camera 132 needs to be provided, and it is preferable to provide two or more cameras in order to enhance imaging precision. The camera 132 may obtain color images or monochrome images.

In the case where the camera 132 is a monocular camera, three-dimensional imaging information can be estimated with use of known SLAM (Simultaneous Localization and Mapping) technology. However, in this case, the camera 132 needs to be moved while taking images. Note that, in principle, the camera 132 can obtain only a relative value of distance, but when positional information of the camera 132 can be obtained from the robot controller 114, it is possible to obtain positional information in a robot coordinate system.

In the case where the camera 132 is a stereo camera, positional information can be obtained from parallax information obtained through known stereo matching. In the case where the camera 132 is a multi-view camera, the principle is the same as that of the stereo camera, and parallax images taken from various directions can be obtained, and therefore, occlusion is unlikely to occur. In the case where the camera 132 is a TOF (Time of Flight) camera, positional information can be obtained based on the time it takes to receive light reflected from a subject after the light is emitted toward the subject. In the case where the camera 132 uses emitted light, positional information can be obtained by performing known pattern projection (projection of a stripe pattern or a random dot pattern).

The lighting device 134 is installed in a surrounding region of a lens of the camera 132 for capturing images, for example, and lights up the cable 104 to be gripped by the gripping device 126 and the connector 110 on the circuit board 108 to which the cable is to be connected, but there is no limitation to this configuration, and the lighting device may also emit pattern light when measuring a distance.

As shown in FIG. 3, the robot controller 114 includes a CPU 156, an input/output device 158 for inputting and outputting signals, and a memory 164 including a RAM 160 and a ROM 162. The CPU 156, the input/output device 158, and the memory 164 are connected to each other via a bus 166 in such a manner that signals can be transmitted therebetween.

The CPU 156 functions as an arithmetic processing device, accesses the memory 164, and reads out and executes various programs stored in the RAM 160, the ROM 162, an external storage device, or the like. The RAM 160 and the ROM 162 are computer-readable recording mediums including programs recorded thereon for controlling the robot body 113, i.e., executing an electronic device assembly method. For example, a program and a device constant used by the CPU 156 are stored in the ROM 162. For example, a program used by the CPU 156 and a variable that varies successively during execution of the program are temporarily stored in the RAM 160. As described above, the robot controller 114 can control the robot body 113 and the gripping device 126 by executing various programs and cause the robot body 113 and the gripping device 126 to execute various functions.

The input/output device 158 of the robot controller 114 includes a communication device, a D/A converter, a motor drive circuit, an A/D converter, and the like, and connects the robot controller 114 to an external device, the electric motors 136, the actuator 150, and various sensors such as the encoders 138 via an interface. Examples of specific communication methods used by the communication device may include data communication in accordance with serial communication standards such as RS232C/485 or USB standards, EtherNET (registered trademark), which is a common network protocol, and EtherCAT (registered trademark) and EtherNet/IP (registered trademark), which are used as industrial network protocols.

The robot controller 114 may also be connected via the input/output device 158 to a storage device for storing data or a drive device that is a reader-writer for recording mediums. The robot controller 114 is not limited to a controller in which dedicated hardware is incorporated, and may also be a general-purpose personal computer that can execute various functions when various programs are installed, for example.

Note that the robot controller 114 controls all of the robot arm 124, the gripping device 126, and the visual device 128, but there is no limitation to this configuration. For example, the robot controller 114 may be configured as a group of a plurality of controllers that respectively control the robot arm 124, the gripping device 126, and the visual device 128, and the plurality of controllers may be connected to each other wirelessly or by cable. Furthermore, the robot controller 114 is provided outside the robot body 113 in the electronic device assembly apparatus 100, but there is no limitation to this configuration, and the robot controller 114 may also be provided inside the robot body 113.

The input device 118 includes an operation means to be operated by a user, such as a keyboard, a mouse, a touch panel, a button, a switch, a lever, a pedal, a remote control means that uses infrared rays or other radio waves, or a personal computer or teaching pendant including these devices. The user who performs the connection work uses the input device 118 to perform input and setting. Note that a program that causes the robot body 113 to execute various functions may be created with use of the input device 118. The program may be written in a low level language such as a machine language or a high level language such as a robot language.

The state notification device 120 receives information regarding an operation state of the robot body 113 and information regarding a state of the leading end 106 of the cable 104 inserted into the connector 110 on the circuit board 108 from the robot controller 114 and displays the information to enable the user to recognize the information visually and intuitively. The state notification device 120 may be a display device such as a liquid crystal panel, a teaching pendant, or a lighting lamp, or a notification device that gives notifications regarding information with use of an alert sound or audio. For example, the state notification device 120 may be set so as to issue an alert when the connection work for inserting the leading end 106 of the cable 104 into the connector 110 has failed. Alternatively, a screen of a personal computer or a teaching pendant may serve as the state notification device 120. The state notification device 120 may include an application for performing input and notification of states.

The upper-level control system 116 is constituted by, for example, a sequencer (PLC), a monitoring and control system (SCADA), a process computer (PROCOM), a personal computer, various servers, or a combination thereof, and connected to the robot controller 114 wirelessly or by cable. The upper-level control system 116 outputs instructions based on operation states of devices that constitute a production line including the robot controller 114, and comprehensively controls the production line.

The upper-level control system 116 can also be used to monitor a defect rate or a cycle time or inspect products by receiving and collecting the time it takes to complete the connection work, a state after the connection work is complete, or the like from the robot controller 114. Furthermore, the upper-level control system 116 may obtain information regarding a state of the operation for gripping the cable 104 with the gripping device 126 of the robot body 113 from the robot controller 114 to cause the robot arm 124 to return to a home position or stop each device.

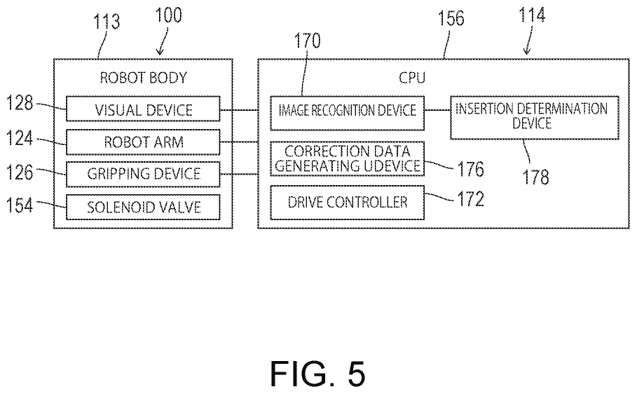

Next, operations of the electronic device assembly apparatus 100 will be described. FIG. 5 is a block diagram showing functions of the electronic device assembly apparatus 100 shown in FIG. 3. FIG. 5 shows functional blocks of the robot body 113 of the electronic device assembly apparatus 100 and functional blocks of the CPU 156 of the robot controller 114.

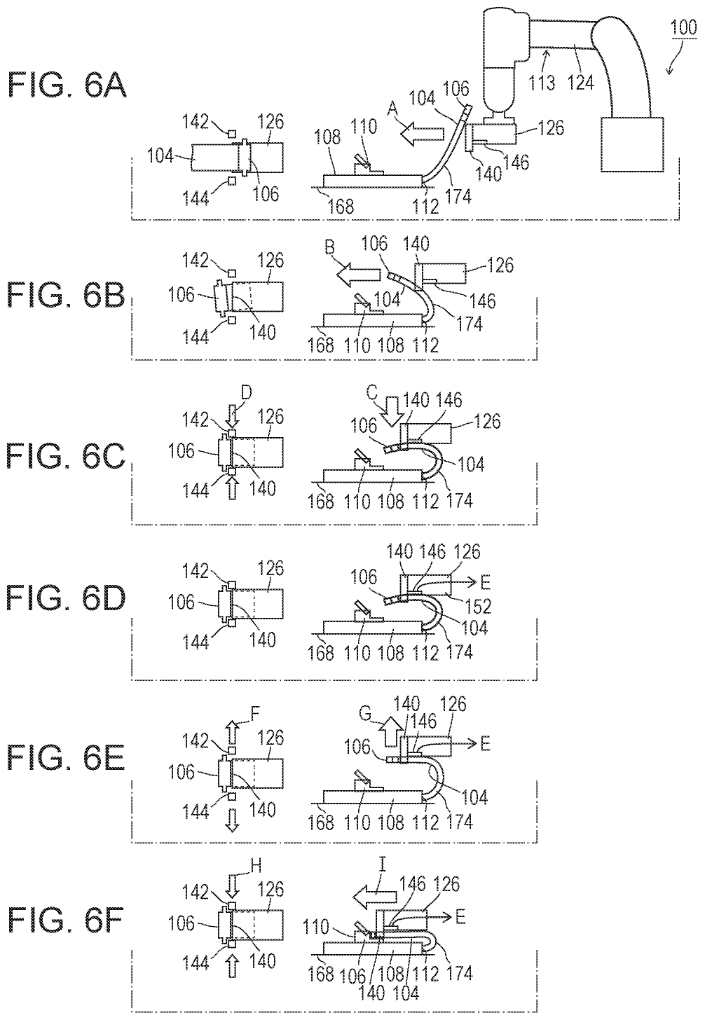

FIGS. 6A to 6F are diagrams showing connection work for connecting the cable 104 with use of the gripping device 126 shown in FIG. 4. In each of FIGS. 6A to 6F, a side view of the gripping device 126 and the cable 104 is shown on the right, and a top view of the gripping device 126 and the cable 104 is shown on the left.

First, in the electronic device assembly apparatus 100, after the circuit board 108 is placed on a table 168 shown in FIG. 6A, an image recognition device 170 included in the CPU 156 recognizes the position and type of the cable 104 based on an image signal obtained from the visual device 128 of the robot body 113. As long as an image signal can be generated, there is no limitation to the configuration in which the visual device 128 is used, and an image of the cable 104 may be obtained with use of a fixed camera installed at a position from which the work area can be viewed from above.

Next, a drive controller 172 outputs a drive signal to the robot arm 124 based on the result of recognition by the image recognition device 170 to cause the robot arm 124 to operate and move the gripping device 126. Thus, the robot arm 124 can move the gripping device 126 relative to the circuit board 108. The drive controller 172 moves the gripping device 126 as shown by the arrow A in FIG. 6A to press the pressing surface 140 of the gripping device 126 against a surface 174 of the cable 104.

The drive controller 172 further advances the gripping device 126 toward the circuit board 108 as shown by the arrow B in FIG. 6B to slide the pressing surface 140 along the surface 174 of the cable 104 while keeping the gripping claws 142 and 144 and the suction holes 146, which serve as the suction device, from operating, and bending the cable 104 with use of the pressing surface 140.

That is, when the pressing surface 140 is slid along the surface 174 of the cable 104 while being pressed against the surface 174 as shown in FIG. 6B, the cable 104 is not restricted in the width direction by the gripping claws 142 and 144 and the surface 174 of the cable 104 is not sucked via the suction holes 146. Therefore, the gripping device 126 can hold multiple types of cables 104 having different widths.

Subsequently, when the pressing surface 140 has been moved to the leading end 106 of the cable 104 by being slid along the surface 174 of the cable 104 as shown in FIG. 6C, the drive controller 172 moves the gripping device 126 downward (see the arrow C). Thus, the cable 104 can be bent more reliably. However, when the gripping device 126 and the cable 104 are viewed from above, the cable 104 may be displaced in the width direction at this time as shown on the left part of FIG. 6B.

Therefore, after moving the gripping device 126 downward, the drive controller 172 causes the gripping claws 142 and 144 to hold the cable 104 as shown by the arrows D in FIG. 6C to correct the displacement of the cable 104 in the width direction.

Next, in the state where the cable 104 is held by the gripping claws 142 and 144, the drive controller 172 controls the solenoid valve 154 (see FIG. 5) to suck the surface 174 of the cable 104 by sucking air via the suction holes 146 as shown by the arrow E in FIG. 6D. That is, the drive controller 172 corrects displacement of the cable 104 in the width direction and then causes the suction holes 146 to suck the surface 174 of the cable 104, and therefore, the position of the leading end 106 of the cable 104 can be stabilized.

However, at this time, the leading end 106 of the cable 104 may extend obliquely downward with respect to the lower surface 152 of the gripping device 126 as shown on the right part of FIG. 6D. Therefore, the drive controller 172 causes the gripping claws to temporarily release the cable 104 as shown by the arrows F in FIG. 6E, and moves the gripping device 126 upward (see the arrow G) in the state where the surface 174 of the cable 104 is sucked via the suction holes 146 (see the arrow E). Thus, it is possible to make the leading end 106 of the cable 104 extend horizontally, and reliably suck the cable 104.

Subsequently, the drive controller 172 causes the gripping claws 142 and 144 to hold the horizontally-extending cable 104 again as shown by the arrows H in FIG. 6F. Furthermore, the drive controller 172 aligns the leading end 106 of the cable 104 with the connector 110. This alignment needs to be performed while giving consideration to variation in the positions of the connector and the leading end of the cable relative to each other due to a positional error made in the operation of gripping the cable 104 with the gripping device 126, an installation error made when the circuit board 108 is placed on the table 168, a positional error made when the connector 110 is mounted on the circuit board 108, or the like.

Therefore, a correction data generating device 176 included in the CPU 156 generates position correction data based on data obtained through recognition by the image recognition device 170, and thus, the electronic device assembly apparatus 100 absorbs variation in the positions of the connector and the leading end of the cable relative to each other. The drive controller 172 can correct a positional error and a posture error by moving the gripping device 126 based on the position correction data. For example, the drive controller 172 extracts feature points of the cable 104 and the connector 110, calculates a position correction amount that realizes an appropriate positional relationship between the feature points, and moves the gripping device 126 and the cable 104.

After alignment between the connector 110 and the leading end 106 of the cable 104 is completed, the drive controller 172 inserts the leading end 106 of the cable 104 into the connector 110 by moving the gripping device 126 as shown by the arrow I in FIG. 6F.

Next, an image of the connector 110 and the cable 104 inserted into the connector 110 is captured by the visual device 128, and an insertion determination device 178 included in the CPU 156 compares the image with an image of a case where insertion is successful. When it is determined through the comparison that the insertion is successful, i.e., the connection work is complete, the processing is ended.

On the other hand, when it is determined by the insertion determination device 178 that the insertion has failed, the insertion determination device 178 may notify the upper-level control system 116 or the user of the occurrence of an abnormality via the state notification device 120 shown in FIG. 3. Also, some measures may be taken such as retrying the connection work. It is also possible to omit automatic determination by the robot system 102 and inspect the circuit board 108 in another step after the insertion is complete.

In the robot system 102 to which the electronic device assembly apparatus 100 is applied as described above, it is possible to hold multiple types of cables 104 having different widths and reliably perform the connection work for connecting the cables 104. Note that the above-described correction of positions can be omitted as appropriate depending on conditions such as positional accuracy of the cable 104 and the connector 110.

In the electronic device assembly apparatus 100, it is possible to omit not only the above-described correction of positions but also the operation of moving the gripping device 126 downward as shown in FIG. 6C and the operation shown in FIG. 6E, i.e., the operation of temporarily releasing the cable 104 from the gripping claws and moving the gripping device 126 upward while the surface 174 of the cable 104 is sucked. In this case, the cable 104 is not released from the gripping claws, and accordingly, the operation of holding the cable 104 again as shown by the arrows H in FIG. 6F is unnecessary.

In the case where these operations are omitted as well, when the pressing surface 140 is slid along the surface 174 of the cable 104 while being pressed against the surface 174, the electronic device assembly apparatus 100 does not restrict the cable 104 in the width direction with use of the gripping claws 142 and 144 and does not suck the surface 174 of the cable 104 via the suction holes 146. Therefore, the gripping device 126 can hold multiple types of cables 104 having different widths.

After the pressing surface 140 has been moved to the leading end 106 of the cable 104, the cable 104 is held by the gripping claws 142 and 144 to correct displacement of the cable 104 in the width direction, and then, the surface 174 of the cable 104 is sucked via the suction holes 146. Thus, the position of the leading end 106 of the cable 104 is stabilized. Accordingly, it is possible to reliably insert the leading end 106 of the cable 104 into the connector 110 on the circuit board 108 by moving the gripping device 126, and thus it is possible to perform connection work for connecting multiple types of cables 114 having different widths.

While a preferred embodiment of the present invention has been described with reference to the attached drawings, it goes without saying that the present invention is not limited to the embodiment. It is clear that those skilled in the art will be able to arrive at various changes and modifications within the scope of the claims, and those changes and modifications are understood to naturally fall within the technical scope of the present invention.

This application is based upon and claims the benefit of priority from the prior Japanese Patent Application No. 2021-110784, filed on Jul. 2, 2021, the above contents are cited in the specification, claims, and drawings of the present application.

### Industrial Applicability

The present invention can be used as an electronic device assembly apparatus and an electronic device assembly method for gripping a cable connected to a circuit board of an electronic device or the like.

### INDEX TO THE REFERENCE NUMERALS

100 . . . electronic device assembly apparatus; 102 . . . robot system; 104 . . . cable; 106 . . . leading end of cable; 108 . . . circuit board; 110 . . . connector; 112 . . . base of cable; 113 . . . robot body; 114 . . . robot controller; 116 . . . upper-level control system; 118 . . . input device; 120 . . . state notification device; 122 . . . base; 124 . . . robot arm; 126 . . . gripping device; 128 visual device; 130 . . . leading end of robot arm; 132 . . . camera; 134 . . . lighting device; 136 . . . electric motor; 138 . . . encoder; 140 . . . pressing surface; 142, 144 . . . gripping claw; 146 . . . suction hole; 148 . . . front surface of gripping device; 150 . . . actuator; 152 . . . lower surface of gripping device; 154 . . . solenoid valve; 156 . . . CPU; 158 . . . input/output unit; 160 . . . RAM; 162 . . . ROM; 164 . . . memory; 166 . . . bus; 168 . . . table; 170 . . . image recognition device; 172 . . . drive controller; 174 . . . surface of cable; 176 . . . correction data generating device; 178 . . . insertion determination device

1. An electronic device assembly apparatus comprising:
a gripping device that grips a flexible flat cable including a leading end that is a free end;
a robot arm that moves the gripping device relative to a circuit board to which a base of the cable has been electrically connected; and
a robot controller that controls operations of the gripping device and the robot arm,
wherein the gripping device includes:
a pressing surface that is provided on a front surface of the gripping device and pressed against a surface of the cable;
gripping claws that are located outward of the pressing surface in a width direction and hold the cable by sandwiching the cable in the width direction; and
a suction device that is provided in a lower surface of the gripping device and holds the cable by sucking the surface of the cable, and
the robot controller
moves the gripping device to press the pressing surface against the surface of the cable,
slides the pressing surface toward the leading end of the cable while bending the cable with use of the pressing surface in a state where the gripping claws and the suction device are not operating,
after sliding the pressing surface, causes the gripping claws to hold the cable to correct displacement of the cable in the width direction,
after holding the cable, causes the suction device to suck the surface of the cable by sucking air, and
moves the gripping device to insert the leading end of the cable into a connector on the circuit board.

2. An electronic device assembly apparatus comprising:
a gripping device that grips a flexible flat cable including a leading end that is a free end;
a robot arm that moves the gripping device relative to a circuit board to which a base of the cable has been electrically connected; and
a robot controller that controls operations of the gripping device and the robot arm,
wherein the gripping device includes:
a pressing surface that is provided on a front surface of the gripping device and pressed against a surface of the cable;
gripping claws that are located outward of the pressing surface in a width direction and hold the cable by sandwiching the cable in the width direction; and
a suction device that is provided in a lower surface of the gripping device and holds the cable by sucking the surface of the cable, and
the robot controller
moves the gripping device to press the pressing surface against the surface of the cable,
slides the pressing surface along the surface of the cable while bending the cable with use of the pressing surface in a state where the gripping claws and the suction device are not operating,
moves the gripping device downward and causes the gripping claws to hold the cable to correct displacement of the cable in the width direction,
causes the suction device to suck the surface of the cable by sucking air,
releases the cable from the gripping claws and moves the gripping device upward while the cable is sucked by the suction device,
causes the gripping claws to hold the cable again, and
moves the gripping device to insert the leading end of the cable into a connector on the circuit board.

3. An electronic device assembly method for inserting a leading end of a flexible flat cable into a connector on a circuit board, the cable including a base that has been connected to the circuit board and the leading end that is a free end, the method comprising:
moving a gripping device including: a pressing surface that is provided on a front surface of the gripping device and pressed against a surface of the cable; gripping claws that are located outward of the pressing surface in a width direction and hold the cable by sandwiching the cable in the width direction; and
a suction device that is provided in a lower surface of the gripping device and holds the cable by sucking the surface of the cable;
pressing the pressing surface against the surface of the cable;
sliding the pressing surface toward the leading end of the cable while bending the cable with use of the pressing surface in a state where the gripping claws and the suction device are not operating;
after sliding the pressing surface, causing the gripping claws to hold the cable to correct displacement of the cable in the width direction;
after holding the cable, causing the suction device to suck the surface of the cable by sucking air; and
moving the gripping device to insert the leading end of the cable into the connector on the circuit board.
